(19) United States
(12) Patent Application Publication
(10) Pub. No.: US 2015/0041556 A1
(43) Pub. Date: Feb. 12, 2015

(54) APPARATUS FOR BLENDING AND DISPENSING MATERIALS, AND RELATED METHODS

(71) Applicant: Spray Tools, Cascade, CO (US)

(72) Inventor: Patrick R. Conarro, Cascade, CO (US)

(73) Assignee: Spray Tools, Cascade, CO (US)

(21) Appl. No.: 14/250,056

(22) Filed: Apr. 10, 2014

Related U.S. Application Data
(60) Provisional application No. 61/811,110, filed on Apr. 11, 2013.

(51) Int. Cl. B01F 5/00; B05B 1/28

(52) U.S. Cl. CPC B01F 5/0077
USPC 239/104

(57) ABSTRACT

An apparatus for blending materials and dispensing the blended materials generally includes a housing, a tip moveably coupled to the housing for dispensing blended materials from the apparatus, and first and second intake units supported by the body and arranged in a generally Y-configuration. The first intake unit has a mixing tube defining a channel for transporting a first material to the tip, and the second intake unit has a mixing tube defining a channel for transporting a second material to the tip for blending with the first material. The first and second intake units also each include a seal coupled to the mixing tube and configured to wrap around a portion of the tip to thereby seal the channel of the mixing tube against the tip.

### CROSS-REFERENCE TO RELATED APPLICATION

This application claims the benefit of and priority to U.S. Provisional Application No. 61/811,110, filed on Apr. 11, 2013. The entire disclosure of the above application is incorporated herein by reference.

### FIELD

The present disclosure generally relates to apparatus for blending and dispensing materials, and methods related thereto.

### BACKGROUND

This section provides background information related to the present disclosure which is not necessarily prior art.

Spray guns are available for dispensing various compounds. In some cases, the compounds are formed from components mixed within the spray guns.

### SUMMARY

This section provides a general summary of the disclosure, and is not a comprehensive disclosure of its full scope or all of its features.

Example embodiments of the present disclosure generally relate to apparatus for blending materials and dispensing the blended materials. In one example embodiment, such an apparatus generally includes a tip for dispensing the blended materials from the apparatus, an intake unit having a mixing tube defining a channel for transporting a material to the tip for blending with another material, and a seal coupled to the mixing tube and configured to wrap around a portion of the tip to thereby seal the channel of the mixing tube against the tip.

In another example embodiment, an apparatus for blending materials and dispensing the blended materials generally includes a housing, a tip moveably coupled to the housing for dispensing blended materials from the apparatus, and first and second intake units supported by the body and arranged in a generally Y-configuration. The first intake unit has a mixing tube defining a channel for transporting a first material to the tip, and the second intake unit has a mixing tube defining a channel for transporting a second material to the tip for blending with the first material.

Example embodiments of the present disclosure also generally relate to methods for using an apparatus configured for blending materials and dispensing the blended materials. In one example embodiment, such a method generally includes directing pressurized air through a solvent cartridge, coupled to the apparatus, to thereby move solvent from the solvent cartridge to a tip of the apparatus.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view of an example embodiment of an apparatus for blending materials according to the present disclosure;

FIG. 1B is another perspective view of the apparatus;

FIG. 2 is a top view of the apparatus;

FIG. 3 is a side view of the apparatus;

FIG. 4 is a top section view of the apparatus;

FIG. 5 is a front view of the apparatus;

FIG. 6 is an exploded perspective view of eth apparatus;

FIG. 7 is a side section view of the apparatus;

FIG. 8 is an enlarged top section view of a tip portion of the apparatus;

FIG. 9 is an enlarged top section view of an intake unit of the apparatus;

FIG. 10 is an enlarged side section view of a solvent dispensing unit of the apparatus;

FIG. 11 is another enlarged side section view of a solvent dispensing unit of the apparatus;

FIG. 12 is a top section view of a rearward portion of a striker assembly of the apparatus;

FIG. 13 is a top view of a central tube portion of the apparatus;

FIG. 14 is a top section view of the central tube portion of FIG. 13;

FIG. 15 is an exploded perspective view of the central tube portion of the apparatus;

FIG. 16 is an exploded perspective view of a valve assembly of the apparatus;

FIG. 17 is a side view of the valve assembly of the apparatus;

FIG. 18 is a side section view of the valve assembly of the apparatus;

FIG. 19 is another side view of the valve assembly of the apparatus;

FIG. 20 is a top view of the valve assembly of the apparatus;

FIG. 21 is another side view of the valve assembly of the apparatus;

FIG. 22 is a perspective view of a solvent cartridge of the apparatus;

FIG. 23 is an exploded perspective view of the solvent cartridge of the apparatus;

FIG. 24 is a side section view of the solvent cartridge of the apparatus;

FIG. 25 is a side view of the solvent cartridge of the apparatus;

FIG. 26 is another side section view of the solvent cartridge of the apparatus;

FIG. 27 is another side view of the solvent cartridge of the apparatus;

FIG. 28 is a schematic illustrating arrangement of the intake units of the apparatus;

FIG. 29 is a schematic illustrating arrangement of the intake units and the solvent dispensing unit of the apparatus;

FIG. 30 is an air and fluid valve circuit schematic of the apparatus;

FIG. 31 is an exploded perspective view of shields and covers for use with the apparatus of FIG. 1; and

FIG. 32 is a perspective view of the apparatus, with the shields and covers installed.

Corresponding reference numerals indicate corresponding parts throughout the several views of the drawings.

### DETAILED DESCRIPTION

The present disclosure generally relates to apparatus and methods for blending and dispensing materials (e.g., chemicals, resins, polymers, hardeners (e.g., isocyanate, etc.), epoxies, ceramics, urethanes, polyureas, polyaspartics, foams, etc. for use in producing coatings, foam, etc.). Plural component chemical blending typically requires equipment that increases temperatures, and pressures of the materials being blended. However, equipment currently available tends to jam, seize up, during operation (e.g., due to cross contamination of materials, thermal expansion of materials within the apparatus, etc.). With that said, the inventor hereof has found that minimizing twists and turns of the materials moving through the apparatus, utilizing chemical purge flushes, and increasing mix ratio turbulence and accuracies of materials moving through the apparatus can help inhibit such seizure, jamming, etc.

In some aspects of the present disclosure, the apparatus and methods provide for blending (e.g., combining, mixing, etc.) materials received from two different starting locations (e.g., plural components, etc.), and then dispensing the combined materials. The materials can include any desired materials within the scope of the present disclosure, for example, resins, hardeners, etc. that, when blended, initiate a reaction that causes the blended materials to generally harden, cure, etc.

In some aspects of the present disclosure, the apparatus are configured for use with off-ratio blends of materials.

As coatings exit the apparatus, fast curing chemicals at high velocities create a stalactite like shape. These unwanted shapes eventually either plug up the tip of the apparatus as they increase in size, or they change the spray pattern from an oval pattern to an arched partial pattern. Thus, in some aspects of the present disclosure, cleaning of residue portions of the materials from the apparatus (e.g., to help insure that materials are not cross contaminating in the apparatus, to help insure that the apparatus (e.g., material flow channels, etc.) is lubricated effectively, etc.). Such cleaning features make use of air operations, mechanical operations, and chemical (e.g., solvent, etc.) operations. In some aspects, these features operate independent of each other; and in other aspects, these features work together in combination. For example, in one example embodiment, when a user releases a trigger of an apparatus and the spray tip is pointing down with respect to gravity, solvent is dispensed into the apparatus. Then when the user points the apparatus up, air is dispensed into the apparatus. These motions are coupled with a delayed mechanical strike to dislodge any residue in the apparatus. In this example embodiment, these three cleaning techniques used together help inhibit material cross contamination and clogging of the apparatus.

In some aspects of the present disclosure, valve assemblies are provided that can be easily uncoupled from the apparatus between uses. For example, typically, the startup/shutdown phase of processing materials requires hoses to be circulated back to the source tank, container, etc. in order to heat and mix the materials. The quick disconnect shape/configuration of the valve assemblies of the apparatus of the present disclosure can provide an improved way to make these coupling events occur more easily. Features are provided in the apparatus to help seal off critical components resulting in fewer failures when the spray apparatus is not being used.

In some aspects of the present disclosure, the apparatus can be either (or both) human hand held (e.g., manually used, etc.) or used in connection with automated operations (e.g., coupled to an end of a robot arm, used in motion defined automation systems, etc.).

In some aspects of the present disclosure, the apparatus are designed to be light weight to thereby naturally benefit manual use by reducing repetitive arm, wrist, and finger fatigue. For example, components of the apparatus can be constructed from lightweight materials, as desired (e.g., ceramics, glass filled nylon, plastics, aluminum, stainless steel, combinations thereof, etc.).

In some aspects of the present disclosure, the apparatus are configured for use with air pressures of about 120 pounds per square inch, and with material pressures of between about 500 pounds per square inch and about 5,000 pounds per square inch. However, higher or lower pressures may be used within the scope of the present disclosure.

In some aspects of the present disclosure, features of the apparatus are provide with generally radial designs. In some aspects of the present disclosure, features of the apparatus are provided with generally loose tolerances. In some aspects of the present disclosure, features of the apparatus are formed from thermally insulating materials that help inhibit the apparatus from overheating during use.

Example embodiments will now be described more fully with reference to the accompanying drawings.

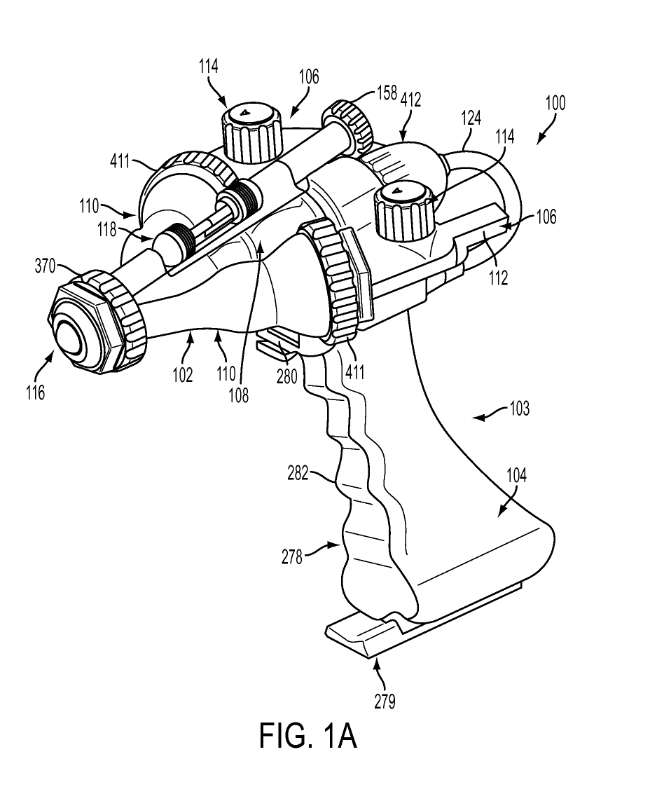

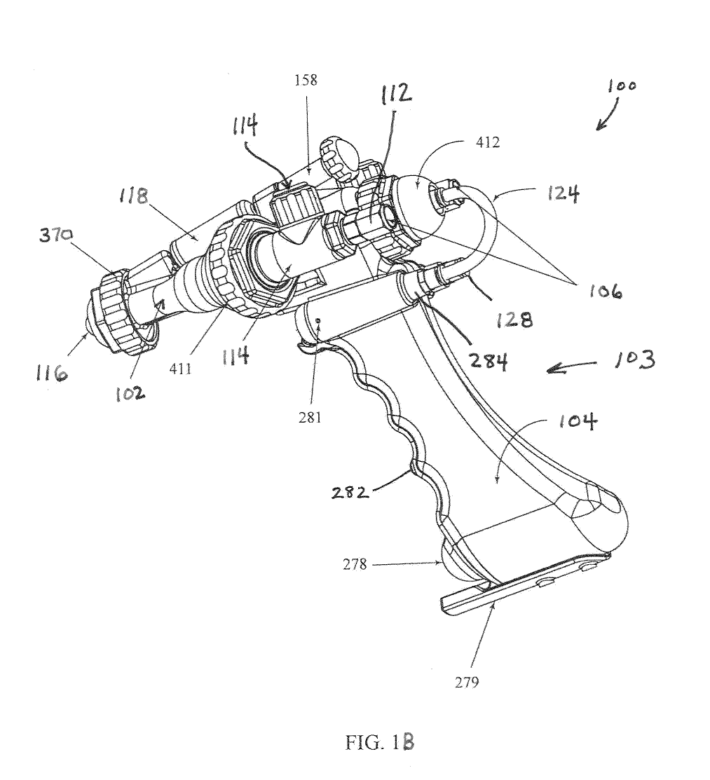

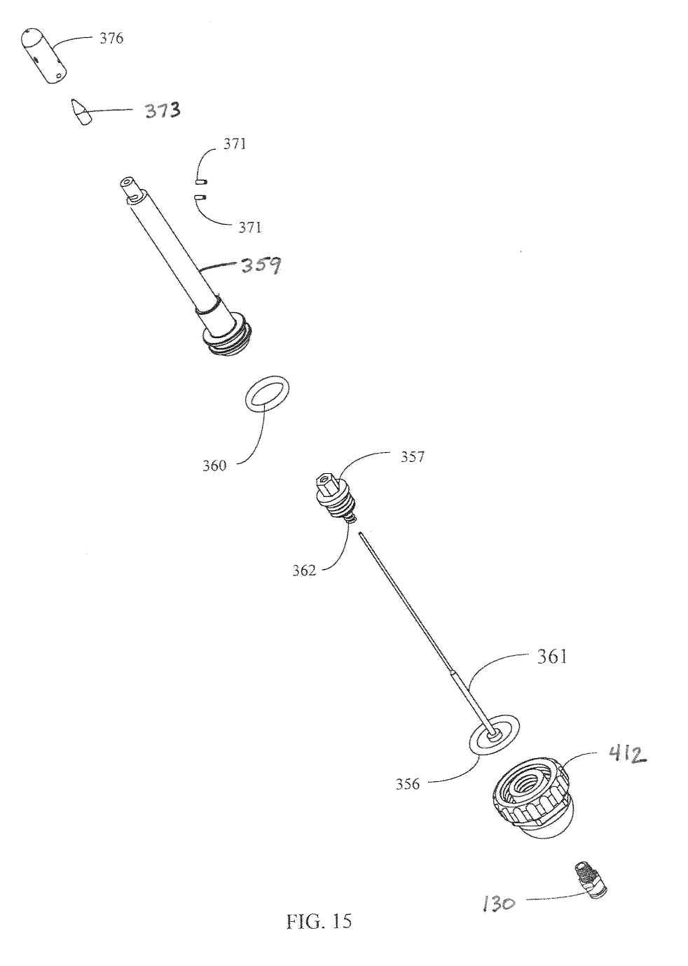

FIGS. 1A-32 illustrate an example embodiment of an apparatus 100 for blending (e.g., combining, mixing, etc.) materials (e.g., resins, hardeners, etc.) and dispensing (e.g., shooting, spraying, etc.) the resulting mixture according to the present disclosure.

The apparatus 100 of this embodiment is configured for receiving two different starting materials into the apparatus 100, mixing the materials, and then dispensing the mixture as desired. The starting materials can include any desired materials within the scope of the present disclosure. As an example, the starting materials may include resins and hardeners that, when mixed (e.g., within the apparatus 100, etc.) initiate an exothermic reaction that causes the mixture to generally harden, cure, etc. when dispensed from the apparatus 100 (e.g., within a short time after initiation of the exothermic reaction, etc.).

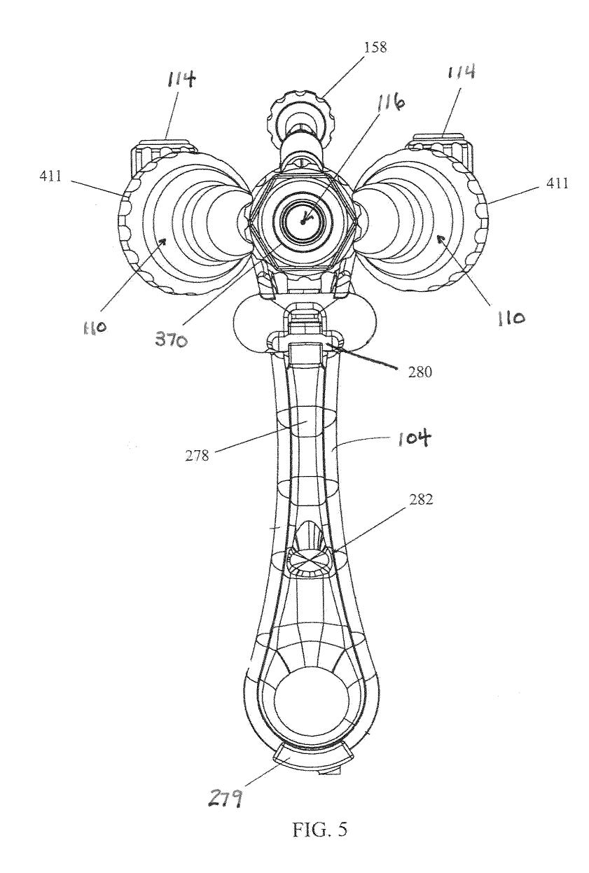

As shown in FIGS. 1A-3, the apparatus 100 generally includes a frame 102, a body 103 coupled to the frame 102, and a pair of valve assemblies 106 coupled to the frame 102. The body 103 has a generally pistol shape and defines a handle 104 for grasping and operating the apparatus 100 (e.g., for use in manually operating the apparatus 100 to mix and dispense materials, etc.). The body 103 generally includes two shells coupled together by a dowel 281. And, a trigger 278 is provided within (e.g., integrated into, etc.) the handle 104 for engagement by a user to selectively operate the apparatus 100 (e.g., for engaging the apparatus 100 to dispense material, for disengaging the apparatus 100 to cease dispensing material, etc.). The trigger 278 extends generally along the length of the handle 104, and pivots about pin 280 (see also FIGS. 5 and 7). In addition, the illustrated handle 104 includes a pronounced knob portion 282 configured to provide a higher leverage point on the handle 104 when a user is actuating the trigger 278. A guard plate 279 is coupled to a lower portion of the handle 104 to help protect the handle 104 and/or trigger 278 from damage if the apparatus 100 is inadvertently dropped. With that said, the body 103, handle 104, trigger 278, etc. may be constructed from suitable materials such as, for example, aluminum, glass filled nylon, combinations thereof, etc. In other example embodiments, apparatus may have bodies with other constructions (e.g., other than two-piece constructions, etc.) and triggers with different shapes.

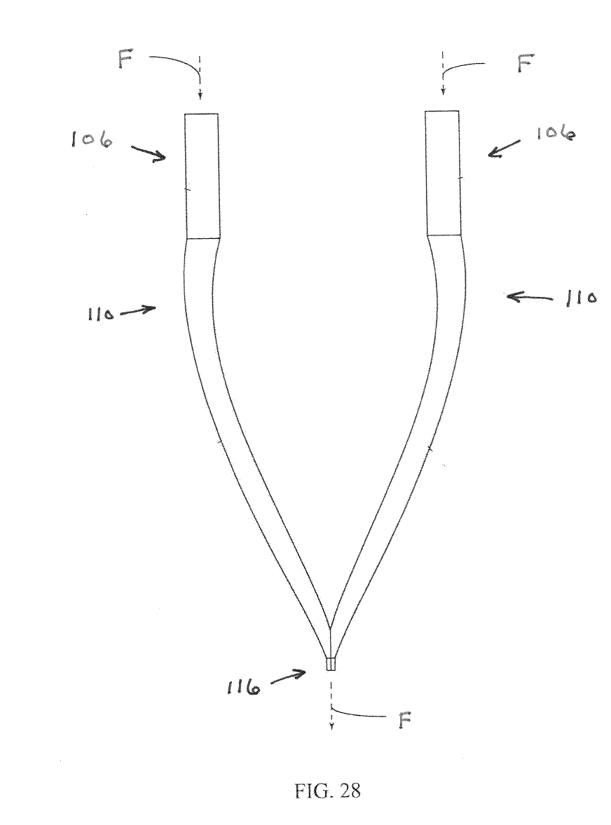

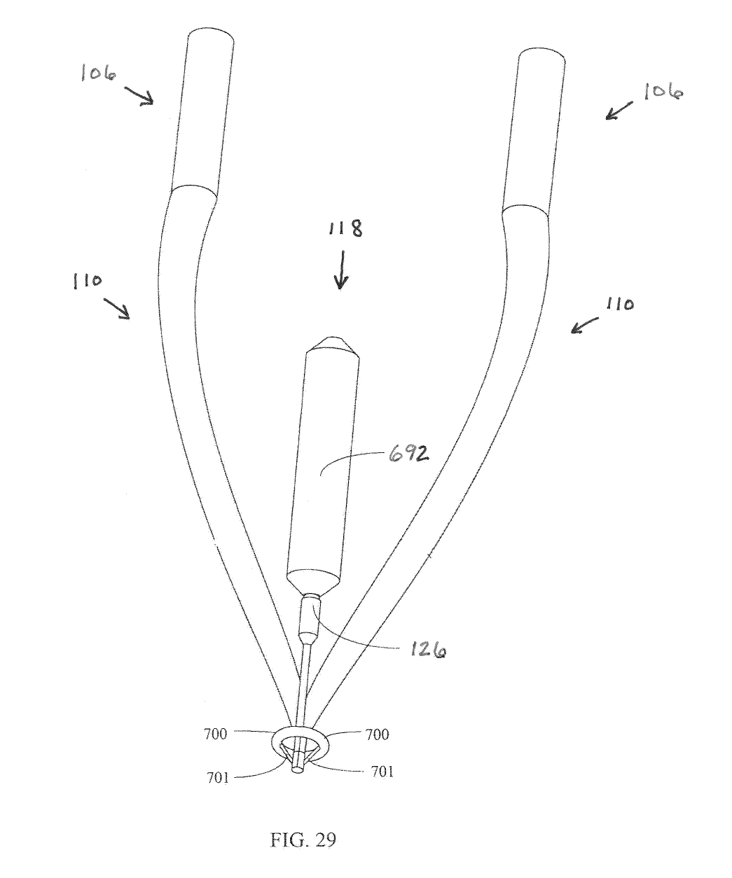

The frame 102 of the apparatus 100 includes a central tube portion 108 and a pair of intake units 110 provided along opposing sides of the central tube portion 108. The intake units 110 are configured to receive and transport desired materials (e.g., consumable components, etc.) to be blended and dispensed through the apparatus 100. In the illustrated embodiment, the intake units 110 are arranged in a generally Y-shaped configuration (e.g., oriented at an angle (e.g., about thirty degrees, etc.) relative to a centerline of the body 103 of the apparatus 100, oriented in a wish-bone configuration, etc.) (see also FIGS. 28 and 29). This configuration helps improve fluid dynamics and reduce pressure drops to the materials as they flow through the body 103 of the apparatus 100 and come together for mixing, for example, under generally high pressure, etc. (e.g., as opposed to pathways that include sharper angles/turns (e.g., pathways with ninety degree angles, etc.)) (see also FIG. 5 which shows how the shape of the intake units 110 brings the materials together with minimal pressure drops). The incoming pressures of the materials perform more naturally, like a hose, rather than right turns in traditional hard plumbing (the pressure drop is a function of the number of turns that the materials take on their path to mixing—when off ratio blends are used, the final exit pressure is uncertain as they are dispensed). This configuration (e.g., separation of the materials as they enter the apparatus 100, etc.) also helps reduce cross contamination of the materials when they enter the apparatus 100 (e.g., premature interactions between the materials, etc. that can clog the apparatus 100, etc.).

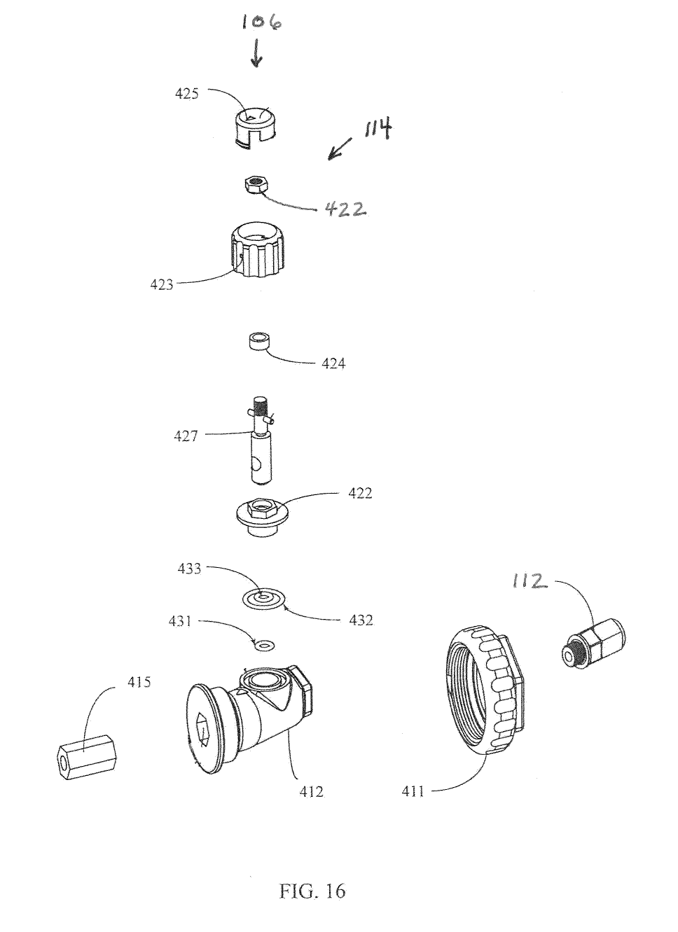

The valve assemblies 106 are coupled to respective ones of the intake units 110. Each of the valve assemblies 106 operates to couple the materials, to the apparatus 100, that are to be blended and dispensed from the apparatus 100. For example, hoses extending from containers (e.g., pressurized containers, containers holding materials at pressures ranging from about 500 pounds per square inch and about 5,000 pounds per square inch, containers holding materials at other pressures, etc.) holding the materials can be coupled (e.g., via wrenches, other tools, etc.) to connectors 112 (e.g., steel swivel connectors, high-pressure connectors, etc.) of the valve assemblies 106 so that the materials can thereby be transported to the apparatus 100 (see also FIGS. 16-21).

With additional reference to FIGS. 16-21, each of the valve assemblies 106 includes a valve 114 for use in controlling flow of the incoming materials into the apparatus 100 (e.g., for turning flow of the incoming materials on and off, etc.) (see also FIG. 18). In addition, each of the valve assemblies 106 includes a disconnect ring 411 (e.g., a threaded ring assembly, etc.) that couples the valve assemblies 106 to the body 103 of the apparatus 100. As such, the valve assemblies 106 can be uncoupled from the body 103 of the apparatus 100 (e.g., via the disconnect ring 411, etc.) to help, for example, facilitate recirculation events for the materials (e.g., the valve assemblies 106 can then be coupled to other containers to help reheat the materials, etc. and then subsequently recoupled to the apparatus 100 for dispensing, etc.), clean the apparatus 100, access and/or clean internal components of the apparatus 100 (e.g., filters, seals, etc.), perform other service on the apparatus 100, transport the apparatus 100, store the apparatus 100, etc. Further, this configuration of the valve assemblies 106 allows the valve assemblies 106 to stay with the hoses. This helps reduce leaks between the hoses and the connectors as they are not repeatedly coupled/uncoupled, and concerns with over tightening are reduced. Further, when the connectors include swivel connectors, they provide the ability for the hoses to twist, turn, etc. such that fewer leaks and/or pressure drops occur. The valve assemblies 106 can be formed from suitable materials such as, for example, aluminum, etc. Each of the valve assemblies also generally includes a body 412, fasteners 422, a knob 423, a spacer 424, a valve stem seat 427, and O-rings 431, 432, 433.

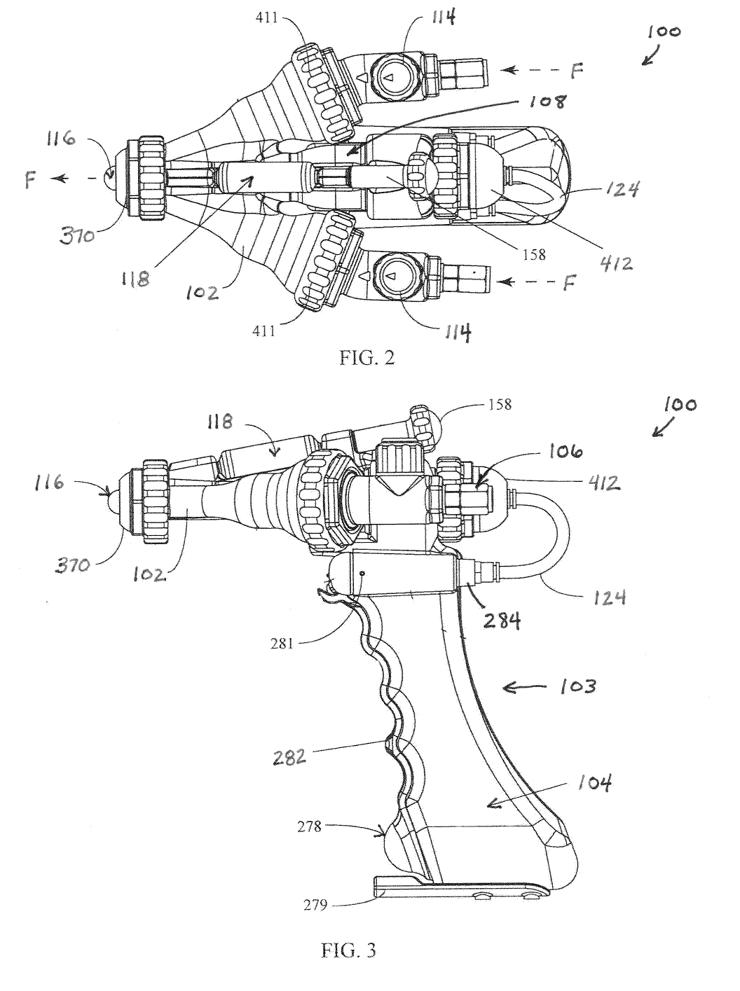

A dispensing tip 116 (e.g., a mixing chamber, etc.) extends through a forward portion of the body 103 of the apparatus 100 for dispensing the materials from the apparatus 100 (arrows F in FIGS. 2, 4, and 28 generally illustrate direction of flow of the materials through the apparatus 100). The tip 116 is configured to move relative to the body 103, for example, into the body 103 when dispensing mixed materials and out of the body 103 when being cleaned. This will be described in more detail hereinafter. The illustrated tip 116 includes a generally radial shape. This helps release any stringers, etc. that may build up when the mixed materials begin their exit from the apparatus 100. The tip 116 may be formed from suitable materials including, for example, ceramics, etc.

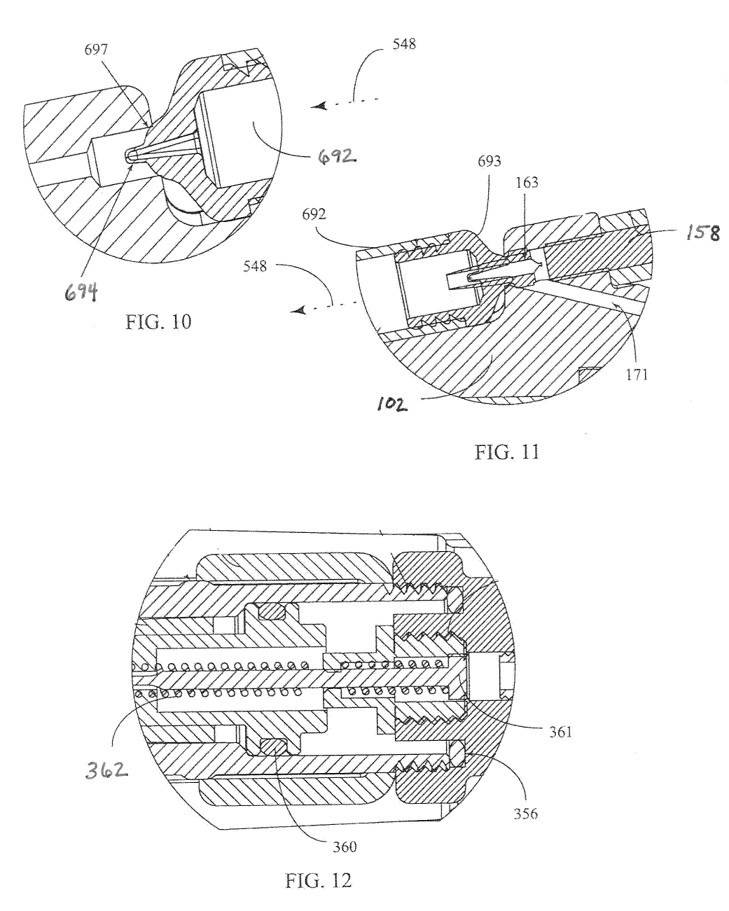

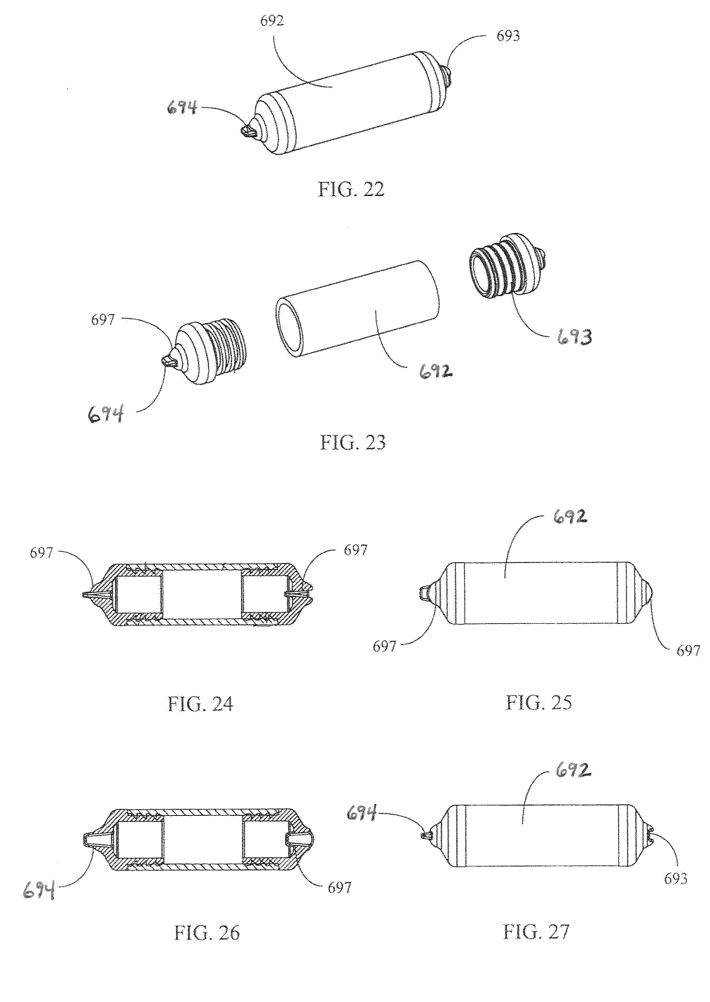

With additional reference to FIG. 6, the apparatus 100 also includes a solvent dispensing unit 118 disposed along an upper portion of the body 103 for use in cleaning the apparatus 100 before, during, after, etc. use. The solvent dispensing unit 118 includes a mount 167 (e.g., a nylon tip trap, etc.) and a fastener 158 for use in coupling a solvent cartridge 692 to the body 103 (e.g., such that the solvent cartridge 692 is seated within the mount 167, etc.). In the illustrated embodiment, the solvent cartridge 692 includes a clear window that allows users to see if the cartridge 692 is full or empty. And, end portions 693, 694 of the cartridge 692 operate as seals (e.g., are made from elastomeric polymers that work as seals, have domed features 697 that help form seals, etc.). The end portions 693, 694 of the cartridge 692 are valves that are generally duckbill shaped and are configured to help hold the solvent in the unit 118 when not pressurized (see also FIGS. 22-27). In use, a user cuts the end portions 693, 694 open and then installs the cartridge 692 into the mount 167. The fastener 158 is then rotated to puncture the end portion 693 of the cartridge 692, and a stream of pressurized air 548 (FIGS. 10 and 11) is then provided (through channel 171 and through openings 163, 164 of the fastener 158) to push the solvent out of the end portion 694 as desired (for distribution into the apparatus 100 (e.g., to flush, lubricate, etc. mixing chamber paths and sealing surfaces in the apparatus 100; to flush, lubricate, etc. the radial-shaped tip 116 of the apparatus 100 to thereby further help release (e.g., self-eject, etc.) any stringers, etc. from the tip 116 that may build up when the mixed materials begin their exit from the apparatus 100, etc.)) (see also FIG. 7 for channeling of pressurized air to the solvent dispensing unit 118 from air valve assembly 543 in the handle 104). This will be described in more detail hereinafter. With that said, the solvent cartridge 692 may include any suitable cartridge (e.g., a consumable-type cartridge, etc.) within the scope of the present disclosure. And, any suitable solvent (e.g., ethylene glycol solvent mixtures, etc.) may be used.

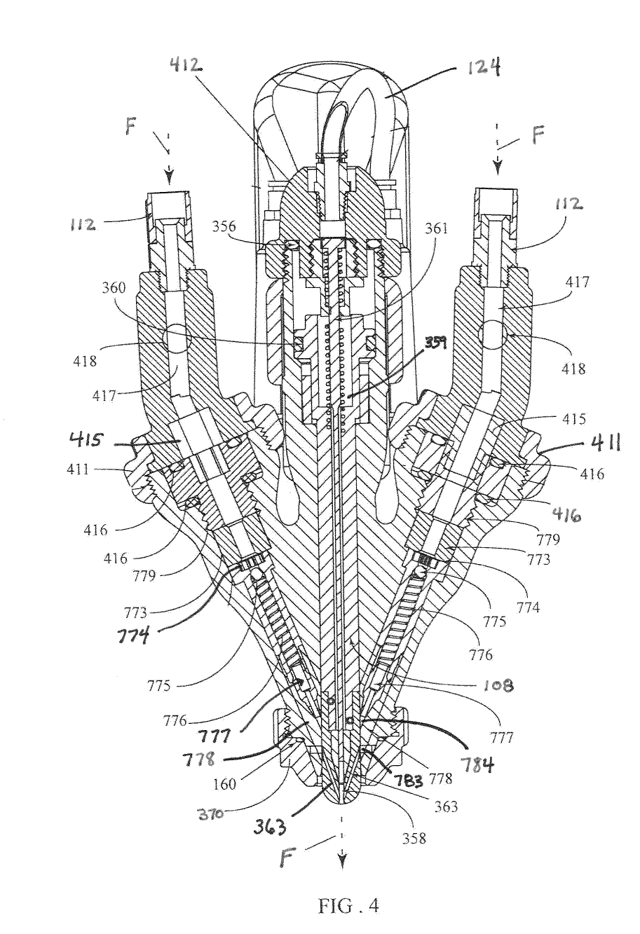

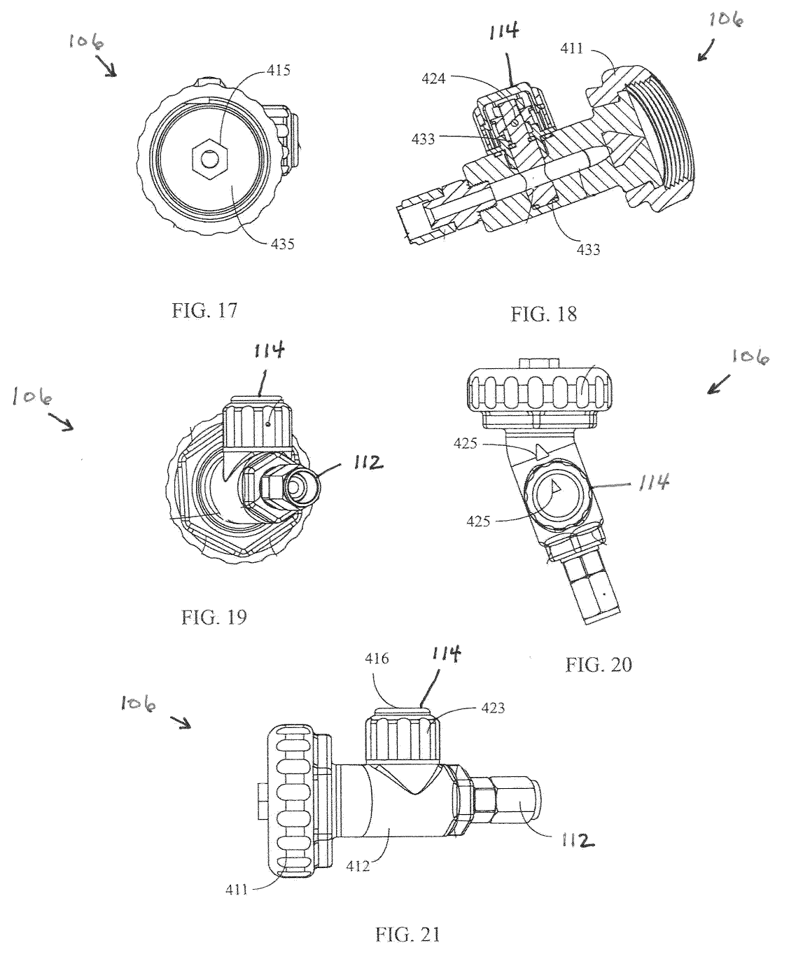

With reference now to FIG. 4, the valve assemblies 106 of the apparatus 100 each include a generally keyed fitting 415 (e.g., a hex-shaped fitting, a hex-shaped opening, etc.) that helps couple the valve assemblies 106 to the corresponding intake units 110 (together with the disconnect rings 411) (see also FIGS. 16, 17, and 21, where FIG. 17 also illustrates a generally flat sealing surface 435 included in each of the valve assemblies 106). These keyed fittings 415 inhibit unwanted rotation of the valve assemblies 106 relative to the intake units 110. And, as assembled, each of the valve assemblies 106 and intake units 110 defines a pathway 417 leading to a mixing tube 777 to allow materials to flow into and generally through the apparatus 100 (with the arrows F in FIGS. 2, 4, and 28 again generally indicating the direction of flow of the materials). In the illustrated embodiment, the pathways also include piloting holes 418 for interaction with the valves 114.

In FIG. 4, the valve assemblies 106 are each shown in a generally open position allowing the apparatus 100 to receive the materials into the pathways 417 (e.g., allowing the materials to flow through the connectors 112 and into the pathways 417, etc.). As the materials move through the disconnect ring 411, O-rings 416 are used to hold pressure of the materials within the pathways 417. When desired, the valve assemblies 106 can be operated (e.g., the valves 114 can be rotated, etc.) to a generally closed position so that the materials are blocked from flowing into the pathways 417 (see also FIG. 20 illustrating visual markers 425 on the valve assemblies 106 that are used to align the direction of the fluid flow, where ninety degrees rotation of the valve 114 is the off position where fluid does not flow). In addition, inline filters (e.g., traps 773 and screens 774, etc.) are provided generally between the pathways 417 and the mixing tubes 777 of the intake units 110. And, check valves (e.g., balls 775 and springs 776, etc.) are provided in the mixing tubes 777 to help inhibit back pressure into the filter areas (see also FIG. 9).

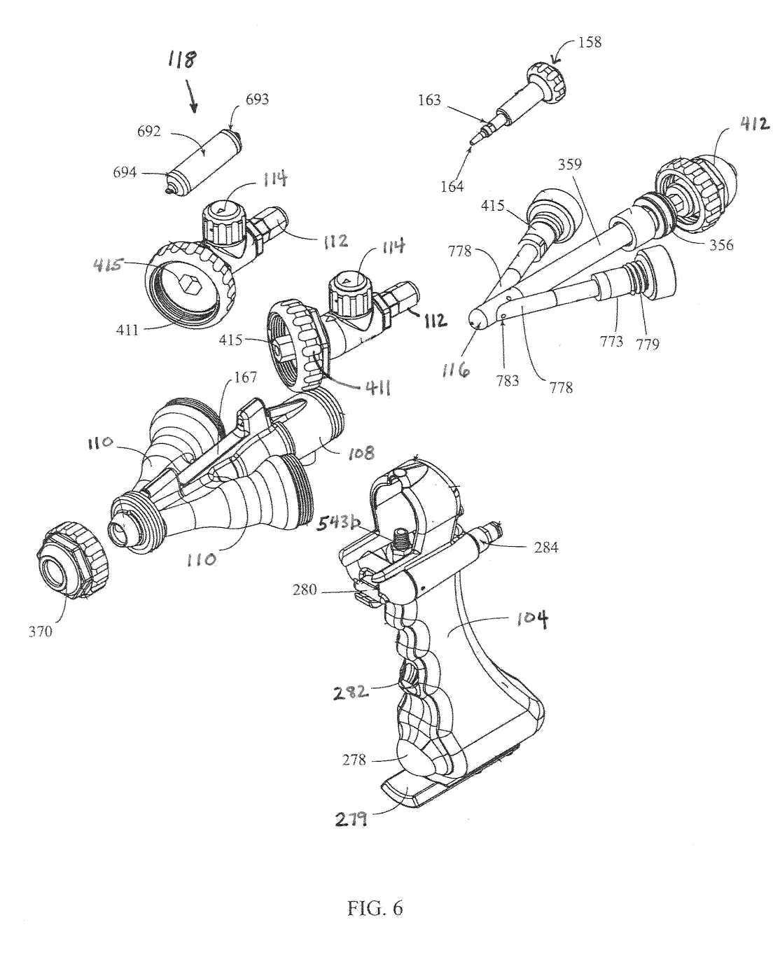

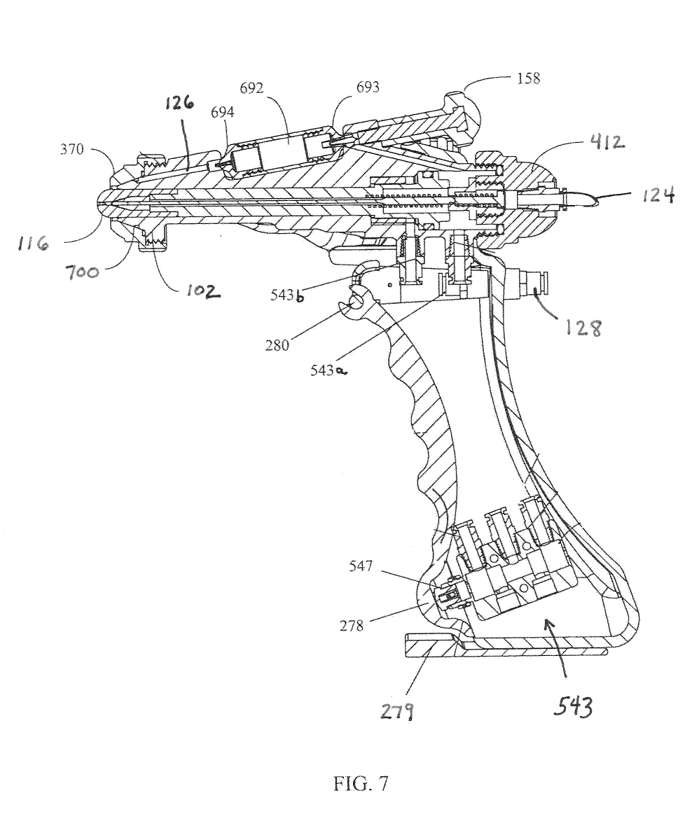

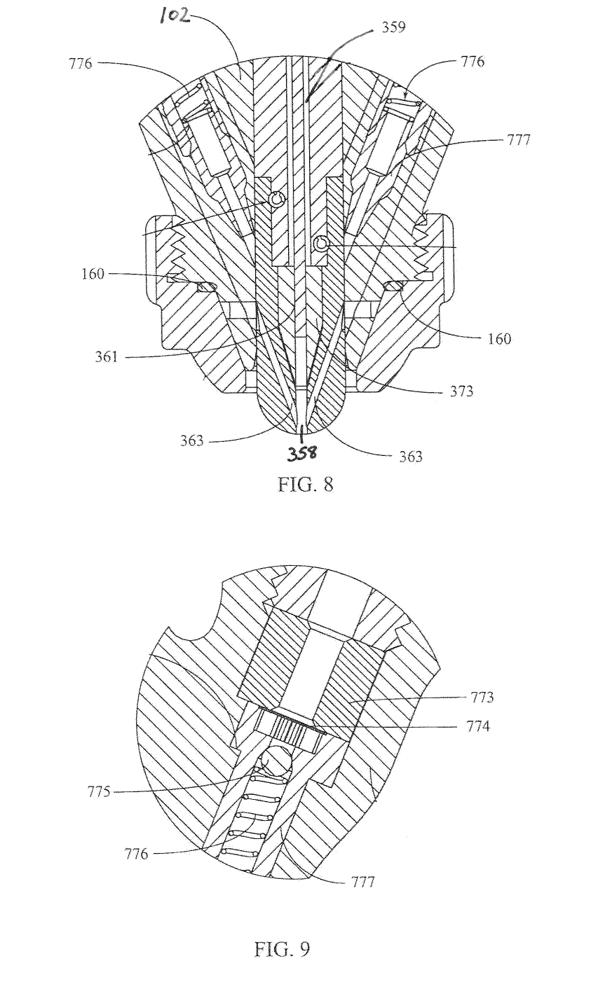

Also in FIG. 4, the tip 116 of the apparatus 100 is shown in an extended position, moved generally out of the body 103 of the apparatus 100 (see also FIG. 8). In this position, the tip 116 blocks flow of the materials from the pathways 417 into the tip 116. When desired to allow such flow, the tip 116 is moved from the extended position to a retracted position, generally within the body 103. Here, the materials can freely flow from the pathways 417, through channels 363 defined through side portions of the tip 116, and into mixing chamber 358 in the tip 116 (where the materials mix and are then dispensed from the apparatus 100). The mixing chamber 358 is sized to accommodate the mixing (and reaction) of the materials, and the volumetric dispensing of the mixed materials. This operation of the tip 116 will be described in more detail hereinafter. It should be appreciated that the channels 363 located in the opposing side portions of the tip 116 (which allow the flow of the two different materials from the two intake units 110) may be sized differently so that off-ratio blends of the materials may be achieved (e.g., blends other than 1:1, etc.).

In the illustrated embodiment, seals 778 are provided around forward end portions of the mixing tubes 777, generally between the mixing tubes 777 and the tip 116 of the apparatus 100. Keyed connections are provided between the seals 778 and the mixing tubes 777. A first set of openings 784 are provided through the seals 778 to allow for movement of the materials through the seals 778 when the tip 116 is in the refracted position. And, a second set of openings 783 are provided through the seals 778 to allow for movement of solvent through the seals 778 when the tip 116 is in the extended position.

The seals 778 help hold pressure of the materials within the pathways 417 and inhibit unwanted leakage of the materials. The seals 778 are configured to generally wrap around at least part of the tip 116 of the apparatus 100 (see also FIG. 6). Forward portions of the seals 778 define generally rounded surfaces that are configured to match the rounded surface of the tip 116. This provides an increased sealing surface area between the seals 788 and tip 116, and helps provide increased sealing between the pathways 417 and the tip 116, particularly when the valve assemblies 106 are in the closed position and the materials in the pathways 417 are under pressure (which can help inhibit the materials from leaking into other parts of the apparatus 100). Threaded inserts 779 of the intake units 110 operate to help trap, hold, etc. the seals 788 against the tip 116. What's more, the seals 788 are generally pliable and thereby allow the sliding movement of the tip 116 into and out of the body 103 of the apparatus 100 while maintaining the desired sealing operations. In addition, the wrap around feature of the seals 788 provides increased sealing with minimal actuation force. Further, the seals 788 allow for changing out chemical restriction ratios as desired. The seals 788 may also help reduce down time of the apparatus 100 as compared to other apparatus 100 because they are generally shaped to follow the contour of the tip 116 of the apparatus 100 (e.g., reduce wear, etc.).

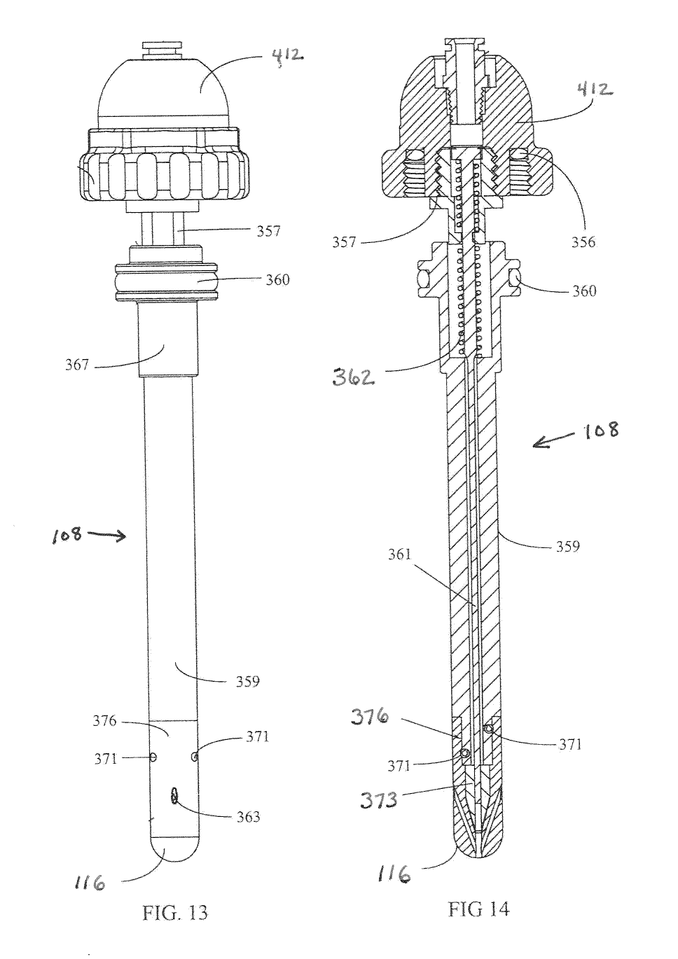

With reference to FIGS. 4, 8, and 12-15, the apparatus 100 also includes a striker pin 361 disposed within a shaft 359 of the central tube portion 108 of the body 103 of the apparatus 100. A forward end portion of the striker pin 361 is located within the tip 116 of the apparatus 100 (generally within a rubber tip portion 373 within the tip 116 and at a location generally where the tip 116 is coupled to a forward end portion of the shaft 359) (FIG. 8). And, a rearward end portion of the striker pin 361 is located within a rear pressure block 412 coupled to the central tube portion 108 of the body 103 (and sealed using O-rings 356). The central portion 108 of the apparatus 100 also generally includes a retainer plug 357, a seal 360, a bushing 367, pins 371, and sheath 376 (FIGS. 13-15).

The striker pin 361 is configured to help remove residue materials from the mixing chamber 358 of the tip 116 of the apparatus 100. To accomplish this, the striker pin 361 is moveable relative to the tip 116 of the apparatus 100. For example, a stream of compressed air (e.g., exhaust air from the handle 104, etc.) is delivered to the pressure block 412 (via fitting 284 and tubing 124) which in turn moves the striker pin 361 forward such that the forward end portion of the striker pin 361 moves into (and through) the mixing chamber 358 to thereby push out any residue material. After this operation, the stream of compressed air is then ceased, and the striker pin 361 retracts out of the mixing chamber 358 of the tip 116 (e.g., via spring 362, etc.).

With additional reference to FIGS. 5 and 7, the solvent dispensing unit 118 of the apparatus 100 includes a solvent cap 370 coupled (e.g., threaded, etc.) to the forward portion of the body 103 of the apparatus 100. The solvent cap 370 defines a channel 700 around the forward portion of the body 103 of the apparatus 100 (see also FIG. 29, where the circular ring around the end of the bottom of the image schematically illustrates the channel 700 and how the solvent is distributed to both sides of the valve assembly (along with line 701)). As such, in use of the solvent dispensing unit 118, solvent flows (under pressure) from the solvent cartridge 692, through a channel 126 in the body 103, and into the channel 700 (see also FIGS. 10 and 11 illustrating how the duck bill valves of end portions 693, 694 are opened to pass air into the solvent cartridge 692 to pressurize the solvent cartridge 692). Then, when the tip 116 of the apparatus 100 is moved to the extended position, the solvent flows from the channels 126, 700 through the seals 778, into the channels 363 of the tip 116 (now generally aligned with the channel 700), and into the mixing chamber 358 of the tip 116. An O-ring 160 is provided to help seal the solvent cap 370 to the body 103 of the apparatus 100 and to help keep the solvent pressurized for exiting, injection, etc. into the tip 116.

As also shown in FIG. 7, the air valve assembly 543 (e.g., a four-way valve assembly, etc.) is provided in a lower portion of the handle 104 of the body 103. Incoming air is provided to the apparatus 100 and the air valve assembly 543 via connector 128, for example, from an air compressor, etc. Tubing extends from the air valve assembly 543 to various connections of the apparatus 100 (see also FIGS. 1A and 1B, and tubing 124, etc.) to thereby provide pressurized air to the desired locations of the apparatus 100. Actuating the trigger 278 operates the air valve assembly 543 via protrusion 547 as desired. The air valve assembly 543 is configured to provide pressurized air to various components of the assembly. For example, the air valve assembly 543 provides pressurized air (e.g., exhaust air, etc.) to the striker pin 361 (via an accumulator in the handle 104 and tube 124) to move the pin 361 relative to the tip 116 to help release residue materials from the tip 116 (see also FIG. 1). For example, the air valve assembly 543 provides pressurized air to the tip 116 (via connector 543a) to help move the tip 116 forward relative to the body 103, as desired, and to provide pressurized air to the solvent dispensing unit 118. And, the air valve assembly 543 also provides pressurized air to the tip 116 (via connector 543b) to help move the tip 116 rearward relative to the body 103, as desired.

An example operation for cleaning the apparatus 100 is described next. Following operation of the apparatus 100 to dispense mixed materials, a cleaning operation starts when the trigger 278 is released. The air valve assembly 543 changes direction and sends air to the shaft 359 of the central tube portion 108 of the body 103 and then on to the solvent cartridge 692. The tip 116 of the apparatus 100 moves forward, and pressurized air initially travels through the solvent dispensing unit 118 and to the tip 116 (the pressurized air passes over the solvent in the cartridge 692). The apparatus 100 is then pointed generally down so that solvent is dispensed into the tip 116 via the pressurized air passing through the solvent cartridge 692. At the same time, air is delayed (via an accumulator in the handle 104) by a few seconds and sent to the striker pin 361 to provide a mechanical strike by the striker pin 361. This air, solvent, and mechanical striking cycle keeps the mixing chamber 358 of the tip 116 clean, lubricated and free of cured materials. When the trigger 278 is actuated again, pressurized air flows to the shaft 359 of the central tube portion 108 of the body 103 to move the tip 116 rearward (so that the materials can again be blended and dispensed).

Another example operation for cleaning the apparatus 100 is described next. Following operation of the apparatus 100 to dispense mixed materials, a cleaning operation starts when the trigger 278 is released. The apparatus 100 is then pointed generally down. The air valve assembly 543 changes direction and sends air to the shaft 359 of the central tube portion 108 of the body 103 and then on to the solvent cartridge 692. The tip 116 of the apparatus 100 moves forward, and pressurized air initially travels through the solvent dispensing unit 118 so that solvent is dispensed into the tip 116 via the pressurized air passing through the solvent cartridge 692. The apparatus 100 is then rotated upright, and pressurized air then passes to the tip 116 (the pressurized air passes over the solvent in the cartridge 692). At the same time, air is delayed (via an accumulator in the handle 104) by a few seconds and sent to the striker pin 361 to provide a mechanical strike by the striker pin 361. This air, solvent, and mechanical striking cycle keeps the mixing chamber 358 of the tip 116 clean, lubricated and free of cured materials. When the trigger 278 is actuated again, pressurized air flows to the shaft 359 of the central tube portion 108 of the body 103 to move the tip 116 rearward (so that the materials can again be blended and dispensed).

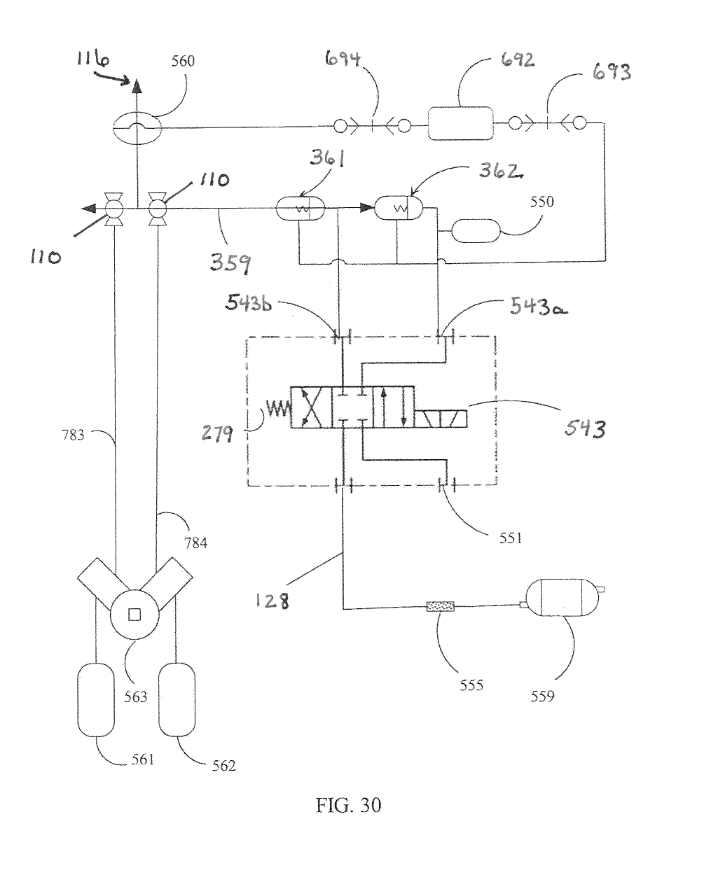

FIG. 30 is an air and fluid valve circuit schematic used to open and close the high pressure valve. The circuit starts with pressurized air (e.g., compressed air 559 through dry air source 555, etc.) arriving into the apparatus 100, via connector 128. Once the air arrives, it is routed through the apparatus 100 via selective actuation of the trigger 279 and air valve assembly 543. In general use, the intake units 110 receive materials 561, 562 into the apparatus 100 (via pump 563 and tubing 783, 784), where they are to be blended and then dispensed through the tip 116 of the apparatus 100. When desired to clean the apparatus 100, for example, the routing of the air by the air valve assembly 543 includes movement of the air through connector 543b, into the shaft 359 (e.g., to move the tip 116 forward, etc.), and then into the solvent cartridge 692 (through end portions 693, 694). The routing of the air also includes movement of the air through connector 543a for moving the striker pin 361. Here, an accumulator 550 is provided to delay the mechanical strike by the pin 361 so that solvent, from the cartridge 692, can enter into the mixing chamber 358 before the mechanical striker pin 361 moves forward (as part of solvent flush circuit 560). The schematic also includes exhaust 551 from the apparatus 100.

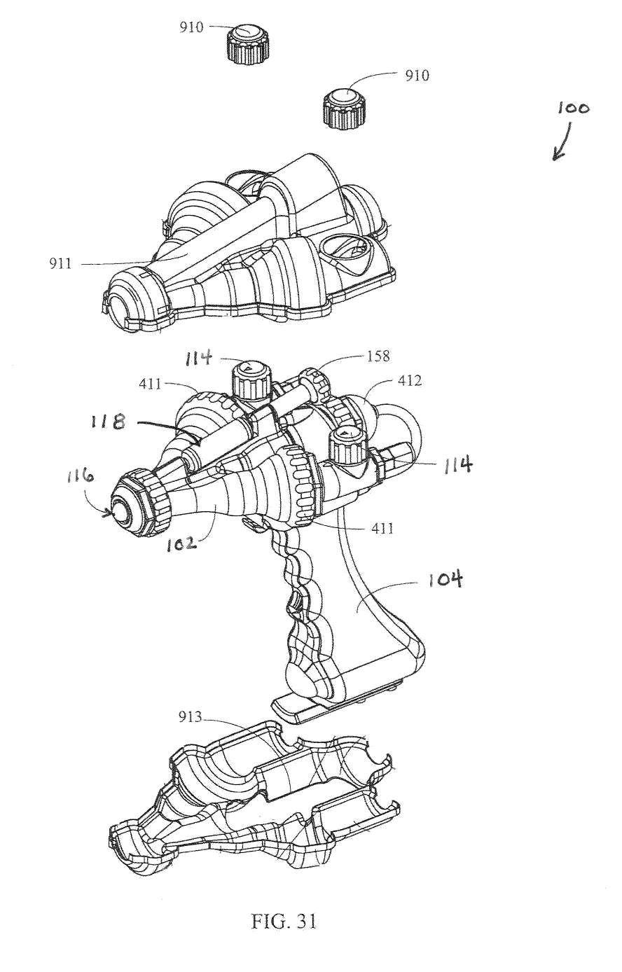

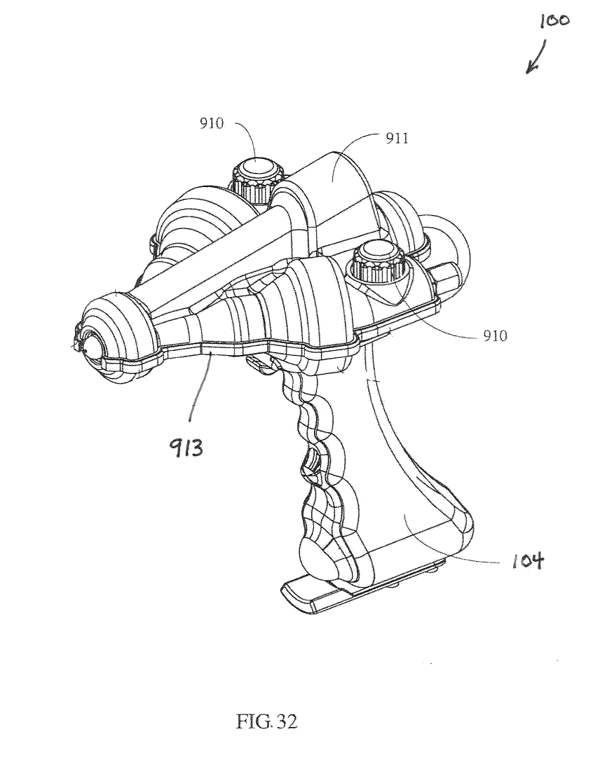

FIGS. 31 and 32 illustrate overspray shields 911, 913 and knob covers 910 for use with the apparatus 100. The knob covers fit generally over valves 114. The shields and covers generally press fit onto the apparatus 100. The shields and covers operate to cover and protect the apparatus 100 from overspray when the gun is used in tight quarters. The overspray shields and knob covers can be formed from suitable materials including, for example, thin transparent plastic so that the fluid levels of the solvent can be seen, etc.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus for blending materials and dispensing the blended materials, the apparatus comprising:
a tip for dispensing the blended materials from the apparatus;
an intake unit having a mixing tube defining a channel for transporting a material to the tip for blending with another material; and
a seal coupled to the mixing tube and configured to wrap around a portion of the tip to thereby seal the channel of the mixing tube against the tip.

2. The apparatus of claim 1, wherein the tip is moveable relative to the seal, and wherein the seal is configured to maintain the seal between the channel of the mixing tube and the tip during such movement of the tip.

3. The apparatus of claim 1, where in the intake unit is a first intake unit and the material is a first material, the apparatus further comprising a second intake unit having a mixing tube defining a channel for transporting a second material to the tip for blending with the first material.

4. The apparatus of claim 3, wherein the first and second intake units are arranged in a generally Y-configuration.

5. The apparatus of claim 4, further comprising a striker pin disposed generally between the first and second intake units and generally aligned with the tip, for removing residue material from the tip.

6. The apparatus of claim 5, further comprising a solvent dispensing unit disposed adjacent the tip for dispensing solvent to the tip for cleaning

7. The apparatus of claim 1, wherein the tip is moveable relative to the intake unit.

8. The apparatus of claim 7, wherein the tip is moveable between a retracted position in which the blended materials can be dispensed from the apparatus, and an extended position in which the materials are blocked from entering the tip.

9. The apparatus of claim 1, wherein the tip defines a generally radial shape.

10. A method for cleaning an apparatus configured for use in blending materials and dispensing the blended materials, the method comprising directing pressurized air through a solvent cartridge, coupled to the apparatus, to thereby move solvent from the solvent cartridge to a tip of the apparatus.

11. The method of claim 10, further comprising directing pressurized air to the tip of the apparatus.

12. The method of claim 11, further comprising moving a pin, moveably coupled to the apparatus, through at least part of the tip of the apparatus.

13. The method of claim 12, wherein moving a pin includes directing pressurized air toward the pin to move the pin through at least part of the tip of the apparatus.

14. An apparatus for blending materials and dispensing the blended materials, the apparatus comprising:
a housing;
a tip moveably coupled to the housing for dispensing blended materials from the apparatus; and
first and second intake units supported by the body and arranged in a generally Y-configuration, the first intake unit having a mixing tube defining a channel for transporting a first material to the tip, and the second intake unit having a mixing tube defining a channel for transporting a second material to the tip for blending with the first material.

15. The apparatus of claim 14, further comprising a striker assembly supported by the body and operable to remove residue material from the tip, the striker assembly disposed generally between the first and second intake units and generally aligned with the tip.

16. The apparatus of claim 15, further comprising a solvent dispensing unit coupled to the body adjacent the tip for dispensing solvent to the tip for cleaning

17. The apparatus of claim 16, wherein the tip is moveable relative to the intake units.

18. The apparatus of claim 17, wherein the tip is moveable between a retracted position in which the first and second materials can be transported to the tip from the first and second intake units for blending, and an extended position in which the first and second materials are blocked from entering the tip.

19. The apparatus of claim 18, wherein the solvent dispensing unit is operable to deliver solvent to the tip when the tip is in the extended position.

20. The apparatus of claim 14, wherein the tip defines a generally radial shape.
